(19) United States
(12) Patent Application Publication
(10) Pub. No.: US 2010/0140090 A1
(43) Pub. Date: Jun. 10, 2010

(54) Gel suspension apparatus

(76) Inventors: Darius Kelly, Rancho Cucamonga, CA (US); Sean Gallagher, Claremont, CA (US)

Correspondence Address: JAMES E. BRUNTON, ESQ., P. O. BOX 29000, GLENDALE, CA, 91209, US

(21) Appl. No.: 12/316,183

(22) Filed: Dec. 9, 2008

(51) Int. Cl. B01D 57/02; C25B 9/00

(52) U.S. Cl. 204/461; 204/612

(57) ABSTRACT

A method and apparatus for expeditiously carrying out the preparation and imaging steps of the electrophoresis process. The apparatus of the invention includes a novel supporting surface comprising TEFLON® AF that acts as a multi-function gel supporting surface which minimizes the probability of damaging the gel during transfer and provides a supporting surface that has an index of refraction lower than that of water and that of water based gel. When the TEFLON® AF supporting surface is used to support the gel, or other mostly aqueous, fluorescent sample, the surface becomes a planar, aqueous core waveguide which traps the excitation light thereby increasing the efficiency of excitation.

### BACKGROUND OF THE INVENTION

1. Field of the Invention

The present invention relates generally to the field of electrophoresis. More particularly, the invention concerns a novel gel preparation substrate and the method of using the substrate.

2. Discussion of the Prior Art

Gel electrophoresis is a widely used technique for separating electrically charged molecules. In accordance with the technique, an electric field is generated to separate charged molecules that are suspended within a gel. The gel is typically a porous matrix generally comprising carbohydrate chains.

“Electrophoresis” refers to the electromotive force that is used to move the molecules through the gel matrix. By placing the molecules in the gel and applying an electric current, the molecules will move through the matrix at different rates, usually determined by mass. Molecules are pulled through the open spaces in the gel, but they are slowed down by the matrix based on their differing properties. The electrophoretic technique can analyze and purify a variety of bio-molecules, but is most frequently used to separate nucleic acids and proteins and is generally done in gels made of a porous insoluble material such as agarose or acrylamide.

After the electrophoresis is complete, the molecules in the gel can be stained to make them visible. The results of the process can then be analyzed quantitatively by illuminating the gel with mono chromatic excitation light light to create phosphorescence and then analyzing the signal emitted using an appropriate imaging device. The image can be recorded with a computer operated camera, and the intensity of the band or spot of interest is measured and compared against a standard or markers loaded on the same gel.

### SUMMARY OF THE INVENTION

During the preparation and imaging steps of the electrophoresis process, the electrophoresis gel can be easily damaged due to the mechanical force applied to the gel during transfer of the gel from one supporting substrate to another. In this regard, gel electrophoresis experiments typically involve three steps, namely running, staining and imaging. During each of these steps it is critical that the supple gel be positively supported by a solid surface. However, at each step, there are different expectations on the supporting surface besides its mechanical property. More particularly, during gel running process, the supporting surface must be electrically inert and during the staining process the supporting surface must be chemically inactive to the labeling agents. The thrust of the present invention is to provide a unique supporting surface that not only meets these requirements but also complements the fluorescence imaging process.

With the forgoing in mind, it is an object of the present invention to provide a novel planar supporting surface that exhibits the desired mechanical, electrical and chemical properties that are required to successfully and expeditiously carry out the preparation and imaging steps of the electrophoresis process.

Another object of the invention is to provide a supporting surface of the aforementioned character that acts as a multi-function gel supporting surface which minimizes gel transfer and minimizes the probability of damaging the gel during transfer.

Another object of the invention is to provide a supporting surface of the character described that has index of refraction lower than that of water and that of water based gel.

Another object of the invention is to provide a novel supporting surface in the method of using same which when used to support the gel, or other mostly aqueous, fluorescent sample, the surface becomes a planar, waveguide which traps the excitation light thereby increasing the efficiency of excitation.

Another object of the invention is to provide a novel supporting surface of the character described in the preceding paragraphs, which when used to support the gel, or other mostly aqueous, fluorescent sample, substantially increases the contrast between excitation light illuminated from a specific angle and the isotropic fluorescence emission.

### BRIEF DESCRIPTION OF THE DRAWINGS

FIG. 1 is a generally perspective view of one form of the gel support of the present invention supporting a conventional gel and superimposed over a conventional gel running container.

FIG. 2 is a generally perspective view of one form of the gel support of the present invention supporting a conventional gel and superimposed over a conventional gel staining solution tray.

FIG. 3 is a generally perspective view of one form of the gel support of the present invention supporting a conventional gel and superimposed over a conventional illumination box having side illumination and also showing a conventional detector superimposed over the gel and gel support.

FIG. 4 is a generally perspective view of an alternate form of the invention showing the gel superimposed over a conventional gel running container.

FIG. 5 is a generally perspective view of an alternate form of the invention showing the gel superimposed over a conventional gel staining solution tray.

FIG. 6 is a generally perspective view of an alternate form of the invention showing the gel superimposed over a novel illumination box having the floor thereof coated with TEFLON® AF, having side illumination and also showing a conventional detector superimposed over the illumination box.

FIG. 7 is a generally perspective view of an alternate form of the gel support of the present invention, supporting a conventional gel having an entrance for side illumination and further showing a right angle prism in engagement with one edge of the gel.

FIG. 8 is a generally perspective view of yet another form of the gel support of the present invention, supporting a conventional gel having an entrance for side illumination.

FIG. 9 is a side elevational view of the apparatus shown in FIG. 8.

### DESCRIPTION OF THE INVENTION

An electrophoresis gel can be easily damaged during the preparation and imaging processes due to the mechanical force applied to transfer the gel from one supporting substrate to another. Typically, gel electrophoresis experiments require three steps; namely running, staining and imaging. At all times the supple gel needs to be supported by a solid surface. However, at each step, there are different expectations on the supporting surface besides its mechanical property. More particularly, during gel running process, the supporting surface must be electrically inert and during the staining process the supporting surface must be chemically inactive to the labeling agents. A planar substrate coated with TEFLON® AF can meet these expectations and even complements a fluorescence imaging process. TEFLON® AF is a rare solid-material that has an index of refraction lower than that of the water and water based gel. When it is used to support the gel or other mostly aqueous, fluorescent sample, the assembly becomes a planar, aqueous core waveguide which traps the excitation light, thus increasing the efficiency of excitation and the contrast between excitation light illuminated from a specific angle and the isotropic fluorescence emission. A TEFLON® AF coated substrate can therefore, act as a multi-function gel supporting surface which minimizes gel transfer and the probability of damaging the gel during transfer.

As will be discussed in greater detail, hereinafter; and as illustrated in FIG. 4 of the drawings, the signal from the stained protein and DNA within electrophoresis gel can be increased by increasing the excitation illumination efficiency. In a manner presently to be described, this can be achieved by using the electrophoresis gel body as a planar waveguide.

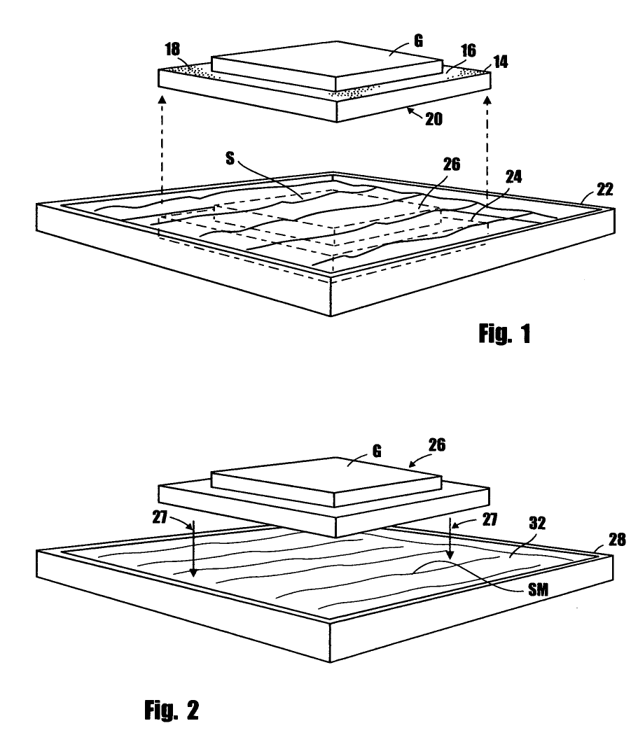

Turning now to the drawings and particularly to FIGS. 1 through 3, one form of the apparatus for conducting a gel electrophoresis experiment is there shown. The apparatus here comprises one form of the important gel support of the present invention, which is generally designated in the drawings by the numeral 14. Gel support 14 here comprises a substrate having a generally planar surface 16 that is provided with a coating 18 of TEFLON® AF to form a first subassembly 20. As previously discussed, TEFLON® AF is a rare solid-material that has index of refraction lower than that of the water and water based gel. When it is used to support the gel in the manner shown in the drawings, the assembly becomes a planar, aqueous core waveguide which traps the excitation light, thus increasing the efficiency of excitation and the contrast between excitation light illuminated from a specific angle and the isotropic fluorescence emission. A TEFLON® AF coated substrate can therefore act as a multi-function gel supporting surface which minimizes gel transfer and the probability of damaging the gel during transfer.

TEFLON® AF is readily commercially available from E. I. du Pont de Nenours & Company of Wilmington, Del.

In FIG. 1, the gel support 14 is shown supporting a conventional gel “G” and is superimposed over a conventional gel running container 22. Gel running container 22 has a chamber 24 for containing a gel running solution “S” and for receiving first subassembly 20 to run the gel to form a second subassembly 26 (see the dotted lines in FIG. 1).

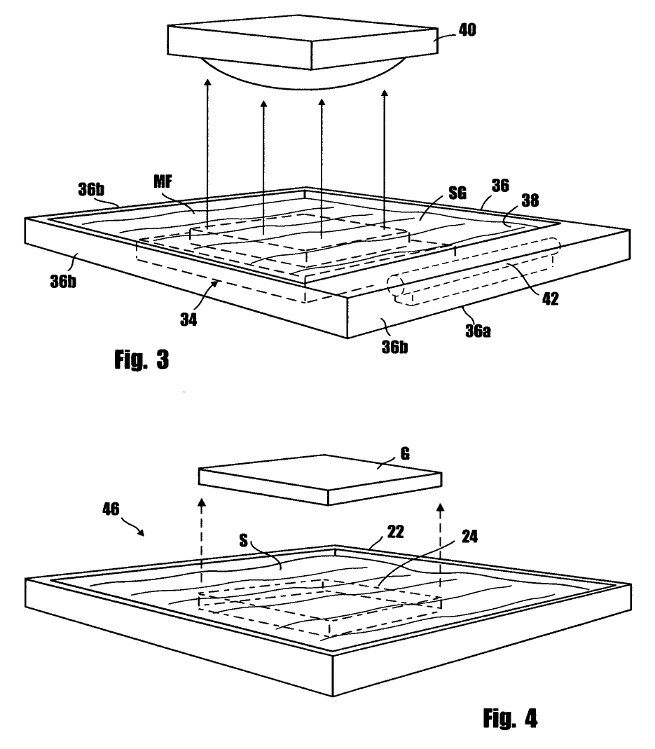

Turning to FIG. 2, the numeral 28 identifies a staining tray that also forms a part of the apparatus of the invention for conducting a gel electrophoresis experiment. Staining tray 28 has a chamber 32 containing a staining medium “SM” for receiving second subassembly 26 in the manner indicated by the arrows 27 of FIG. 2. In a conventional manner, the staining medium “SM” is used to stain the gel “G” to form a third subassembly 34 that includes a stained gel “SG” (see FIG. 3).

Also forming a part of the apparatus of the invention for conducting a gel electrophoresis experiment is an illumination box assembly 36 having a base 36a, plurality of side walls 36b connected to said base to form a chamber 38 containing a matching fluid “MF” for receiving third subassembly 34 in the manner illustrated in FIG. 3. Illumination box assembly 36 uniquely includes side illumination means for illuminating the stained gel “SG” to create fluorescence that is detected in a conventional manner by a detector 40 that is disposed proximate the illumination box assembly for detecting the fluorescence emitted from the stained protein and DNA within the gel “SG”. The side illumination means can take various forms, including fluorescent lamps, light emitting diodes, external electrode fluorescent lamps and cold cathode fluorescent lamps, but is here shown as a conventional fluorescent lamp 42.

Turning next to FIGS. 4 through 7 of the drawings, an alternate form of the apparatus of the invention for conducting a gel electrophoresis experiment is there shown and generally identified by the numeral 46. This apparatus is similar in many respects to the apparatus shown in FIGS. 1 through 3 and like numerals are used in FIGS. 4 through 6 to identify like components.

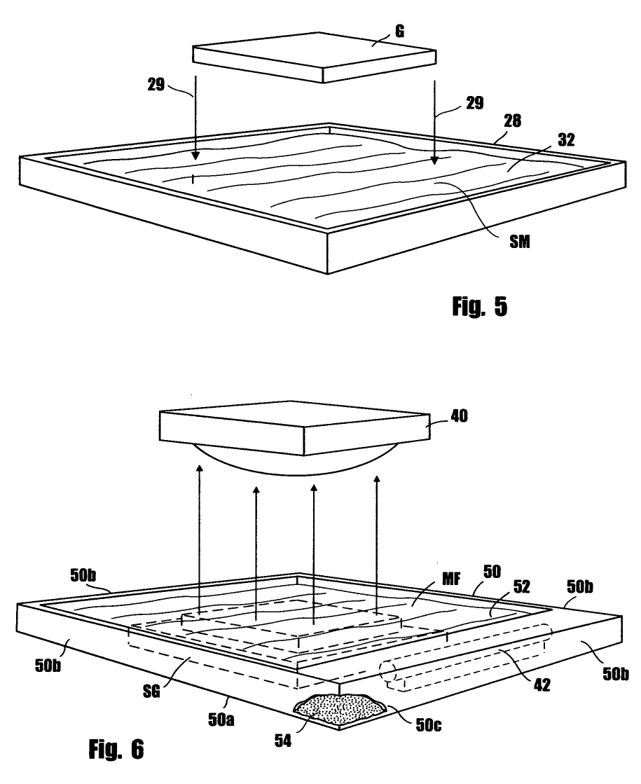

The apparatus here comprises a conventional gel running container 22 having a chamber 24 for containing the gel running solution. Once submerged in the gel running solution, the gel is run in a conventional manner (see the dotted lines in FIG. 4). Turning to FIG. 5, the numeral 28 identifies a staining tray that also forms a part of the apparatus of the invention for conducting a gel electrophoresis experiment. Staining tray 28 has a chamber 32 containing a staining medium “SM” for receiving the gel “G” in the manner indicated by the arrows 29 of FIG. 5. In a conventional manner, the staining medium “SM” is used to stain the gel “G” to form a stained gel.

As before, forming a part of the apparatus of this latest form of the invention for conducting a gel electrophoresis experiment is an illumination box assembly 50 having a base 50a and a plurality of side walls 50b connected to said base to form a chamber 52 containing a matching fluid “MF” for receiving the stained gel in the manner illustrated in FIG. 6. Illumination box assembly 50 includes a generally planar base floor 50c having an interior surface that is uniquely coated with a coating 54 of TEFLON® AF upon which the stained gel rests.

Illumination box assembly 50 also includes a side illumination means for illuminating the stained gel “SG” to create fluorescence that is detected in a conventional manner by a detector 40 that is disposed proximate the illumination box assembly for detecting the fluorescence emitted from the stained protein and DNA within the gel “SG”. When the TEFLON® AF coated floor 50c is used to support the stained gel in the manner shown in FIG. 6 of the drawings, the assembly becomes a planar, aqueous core waveguide which traps the excitation light, thus increasing the efficiency of excitation and the contrast between excitation light illuminated from a specific angle and the isotropic fluorescence emission.

The side illumination means can take various forms, including fluorescent lamps, light emitting diodes, external electrode fluorescent lamps and cold cathode fluorescent lamps, but is here shown as a conventional fluorescent lamp 42.

One form of the method of the invention for conducting a gel electrophoresis experiment using the apparatus illustrated in FIGS. 1 through 4 comprises the following steps: First, first subassembly 20 that is made up of gel “G” and support 14 is positioned within the chamber of the gel running container 22 to run the gel to form a second subassembly 26. Next, the second subassembly 26, that is the gel along with the substrate, is lifted and submerged into the staining medium “SM” to stain the gel to form a third subassembly 34 that includes the stained gel “SG” After the staining process is completed, the third subassembly 34 is carried to the imaging environment and submerged within the index matching fluid “MF”. Using the illumination means, or fluorescent lamp 42, the stained gel “SG” is then illuminated to create fluorescence. Finally, the fluorescence is detected using the detector an appropriately analyzed.

An alternate form of the method of the invention for conducting a gel electrophoresis experiment using the apparatus illustrated in FIGS. 4 through 6 comprises the following steps: First, the gel “G” is positioned within the chamber of the gel running container 22 to run the gel. Following the gel running step the gel is lifted and submerged into the staining medium “SM” to stain the gel to form a stained gel “SG” After the staining process is completed, the stained gel is carried to the imaging environment and submerged within the index matching fluid “MF” so that it rests on the TEFLON® AF coated floor of the illumination box. Using the illumination means, or fluorescent lamp 42, the stained gel “SG” is then illuminated to create fluorescence. Finally, the fluorescence is detected using the detector and appropriately analyzed.

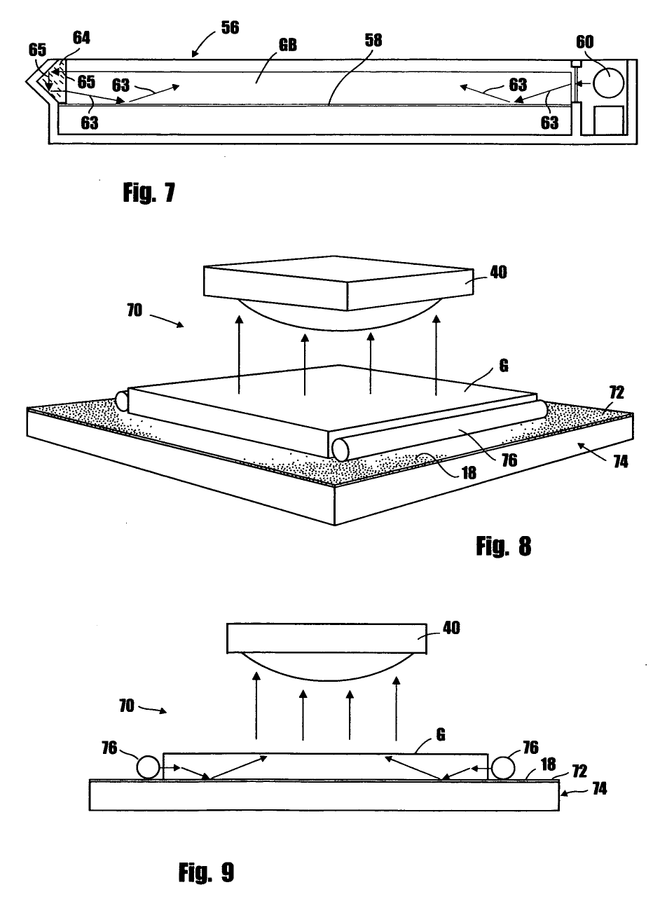

Referring now to FIG. 7 of the drawings, an alternate form of the apparatus of the invention for conducting a gel electrophoresis experiment is there shown and generally identified by the numeral 56. This apparatus was designed based on the premise that the signal from fluorescently stained electrophoresis gel can be increased by increasing the excitation illumination efficiency. The present inventors have determined that this result can be achieved by using the apparatus illustrated in FIG. 7 wherein the electrophoresis gel body “GB” is used as a planar waveguide. With this approach, excitation rays perform total internal reflection at the interface and, therefore, continue to travel within the gel and increase the chance of resulting in excitation of fluorescence. To reach the condition of total internal reflection (TIR), the neighboring material (cladding) must have a refractive index (n) smaller than that of the waveguide core, when using the gel body as a planar waveguide (n=1.33). As illustrated in FIG. 7, TEFLON® AF 2400 (n=1.29) or other material that has refractive index smaller than 1.33 acts as both the supporting substrate 58 and the bottom surface cladding. Air (n==1) acts as the upper surface cladding. Side excitation in the form of a fluorescent lamp 60 is used to excite the gel body. As indicated by the arrows 63 in FIG. 7, this arrangement creates the condition to retain some scattered, or off-axis excitation rays within the gel body and thus increase the fluorescence emission. A novel feature of this alternate form of the apparatus of the invention is the provision of a conventional right angle prism 64 that is attached to the edge of the waveguide in the manner shown in FIG. 7. As indicated by the arrows 65, prism 64 functions to cause the non-off-axis excitation rays to reflect internally of the prism and return to the gel body.

Referring now to FIGS. 8 and 9 of the drawings, yet another form of the apparatus of the invention for conducting a gel electrophoresis experiment is there shown and generally identified by the numeral 70. This apparatus is similar in some respects to the earlier described apparatus of the invention and like numerals are used in FIGS. 8 and 9 to identify like components. Apparatus 70 comprises an alternate form of the important gel support of the present invention and here includes a substrate having a generally planar surface 72 that is provided with a coating 18 of TEFLON® AF to form a first subassembly 74. As previously discussed, TEFLON® AF is a rare solid-material that has index of refraction lower than that of the water and water based gel. When it is used to support the gel in the manner shown in FIGS. 8 and 9 of the drawings, the assembly becomes a planar, waveguide which traps the excitation light, thus increasing the efficiency of excitation and the contrast between excitation light illuminated from a specific angle and the isotropic fluorescence emission. As before, the TEFLON®. AF coated substrate therefore acts as a multi-function gel supporting surface which minimizes gel transfer and the probability of damaging the gel during transfer.

In FIGS. 8 and 9, the gel support 72 is shown supporting a conventional gel “G”. Also forming a part of the apparatus of the invention for conducting a gel electrophoresis experiment is a source of illumination that here comprises side illumination means for illuminating the gel “G” to create fluorescence that is detected in a conventional manner by a detector 40 that is disposed proximate the gel for detecting the fluorescence emitted from the stained protein and DNA within the gel. The side illumination means can take various forms, including fluorescent lamps, light emitting diodes, external electrode fluorescent lamps and cold cathode fluorescent lamps, but is here shown as a pair of conventional fluorescent lamps 76 disposed in close proximity with the sides of the gel. With this novel construction, and as indicated by the arrows in FIG. 9, excitation rays perform total internal reflection at the interface and therefore continue to travel within the gel and increase the chance of resulting in excitation of fluorescence.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

We claim:

1. A gel support for use in conducting an electrophoresis experiment comprising a surface having a coating of TEFLON® AF thereon.

2. The gel support as defined in claim 1 in which said surface includes a generally planar portion, said coating of TEFLON® AF being formed on said generally planar portion.

3. The gel support as defined in claim 1 in which said gel support comprises a container, including a base and a plurality of side walls connected to said base to form a chamber, said base having a generally planar floor portion, said coating of TEFLON® AF being formed on said generally planar floor portion.

4. An apparatus for conducting a gel electrophoresis experiment comprising:
(a) a substrate having a generally planar surface having a coating of TEFLON® AF thereon;
(b) a gel disposed on said coating of TEFLON® AF to form a first subassembly;
(c) a gel running container having a chamber for receiving said first subassembly to run said gel to form a second subassembly;
(d) a staining tray having a chamber containing a staining medium for receiving said second subassembly to stain said gel to form a third subassembly that includes a stained gel;
(e) an illumination box assembly having a chamber containing a matching fluid for receiving said third subassembly, said illumination box assembly having side illumination means for illuminating said stained gel create fluorescence; and
(f) a detector disposed proximate said illumination box assembly for detecting said fluorescence.

5. The apparatus as defined in claim 4 which said side illumination means for illuminating said stained gel comprises a fluorescent lamp.

6. A method for conducting a gel electrophoresis experiment using an apparatus comprising a substrate having a generally planar surface having a coating of TEFLON® AF thereon; a gel disposed on the coating of TEFLON® AF to form a first subassembly; a gel running container having a chamber; a staining tray having a chamber containing a staining medium; an illumination box assembly having a chamber containing a matching fluid, said illumination box assembly having side illumination means; and a detector disposed proximate the illumination box, said method comprising the steps of:
(a) positioning the first subassembly within the chamber of the gel running container to run the gel to form a second subassembly;
(b) positioning the second subassembly within the staining medium to stain the gel to form a third subassembly that includes a stained gel;
(c) positioning the third subassembly within the matching fluid and, using illumination means, illuminating the stained gel to create fluorescence; and
(d) using the detector, detecting the fluorescence.

7. A method of for conducting a gel electrophoresis experiment using an apparatus comprising a gel running container having a chamber; a staining tray having a chamber containing a staining medium; an illumination box assembly having a chamber containing a matching fluid, said illumination box assembly having a generally planar floor coated with TEFLON® AF and side illumination means; and a detector disposed proximate the illumination box, said method comprising the steps of:
(a) positioning the gel within the running container to run the gel;
(b) following running the gel, positioning the gel within the staining medium to stain the gel to form a stained gel;
(c) positioning the stained gel within the matching fluid and, using illumination means, illuminating the stained gel to create fluorescence; and
(d) using the detector, detecting the fluorescence.
